(19) United States
(12) Patent Application Publication
(10) Pub. No.: US 2008/0186161 A1
(43) Pub. Date: Aug. 7, 2008

(54) System and method for tracking, locating, and guiding personnel at a location

(76) Inventors: John W. Fussner, Mason, OH (US); Mark A. Woods, Morrow, OH (US)

Correspondence Address: Mark F. Smith, 905 Ohio Pike, Cincinnati, OH, 45245, US

(21) Appl. No.: 11/701,569

(22) Filed: Feb. 2, 2007

(51) Int. Cl. H04Q 7/00

(52) U.S. Cl. 340/539.13

(57) ABSTRACT

A system and method for tracking, locating, and guiding personnel at a location, preferably is a computer-aided system that operates to provide a communication system whereby individuals can be tracked and guided and can communicate with a central processing and communication system as well as other individuals within the system. In a preferred embodiment of the invention, the system comprises deployable sensor arrays.

### BACKGROUND OF THE INVENTION

This invention relates to a system and method for tracking, locating, and guiding personnel at a location, and more particularly, to a system and method for tracking, locating, and guiding personnel, such as for example rescue emergency personnel, at a defined location.

Emergency personnel, such as firefighters, often arrive at locations, such as buildings, where adverse conditions exist. Smoke, fire, the absence of light sources, and the like often make it difficult for the firefighter or other emergency personnel to see the surroundings. Further, emergency personnel can become disoriented and are unable to navigate their way to a desired destination. This is particularly difficult at locations, such as in large or complex building structures, city neighborhoods, woods or forest areas. Consequently, various systems have been developed to track, locate and guide emergency personnel at such locations or while driving in a vehicle.

One exemplarily example of a system for tracking and locating personnel in a building structure is shown and described by Navab in U.S. Pat. No. 6,675,091. The system and method disclosed utilizes tracking devices that are affixed to placeholders at various locations within the building. The tracking devices are used in conjunction with the building's floor plans to track, locate and guide individuals within the building. Various devices, such as hand-held devices or heads-up display units, can be used to relay information to the emergency personnel. Systems such as described above however require emergency personnel to carry and place such tracking devices in their proper locations. This can be undesirable when emergency personnel are carrying other equipment or when time is critical. Further, such systems are not practical for emergency personnel that are called into service at locations that do not have defined placeholders or previously installed tracking devices.

Another system that has been developed is shown and described by Saitta in U.S. Pat. No. 6,898,559. The system discloses the use of a transducer system that uses a signal that determines the present distance from the user to various building structures, such as walls, doors, windows, and the like, which is then used to automatically map the rooms of the building. The system uses an inertial guidance system that utilizes gyroscopes, accelerometers, and magnetometers, to monitor and measure the movement of the user, including rotation and acceleration caused by walking and turning, to locate the user with respect to a known reference point. The system also permits the user to receive a heads-up display allowing the user to visualize the layout of the building and allows other information to be collected, such as ambient temperature, presence of toxic gases, breathing rate and heart rate of the user, and other similar data. Unfortunately, such systems are relatively large, complex, and expensive and are not easily worn by emergency personnel. Accordingly, personnel would typically not wear the device at all times and must therefore take time to attach the device on themselves before entering into the building or an emergency situation.

Other tracking systems, such as those using global tracking satellites (GPS) have been developed for tracking personnel. Unfortunately, the accuracy of global positioning systems is affected by a number of external influences. For example, atmospheric and ionospheric conditions and satellite clock errors, for instance, can affect GPS accuracy. Thus, for use by emergency personnel, such as firefighters, relatively expensive systems must be used to maximize accuracy. Further, buildings and other structures often block tracking signals such as high frequency signals used by GPS devices thus making them undesirable or limited in use for many emergency operations.

Accordingly, what is needed is a system and method for tracking, locating, and guiding personnel that is relatively light weight and small in size, inexpensive to manufacture and operate, and which can be easily and quickly implemented, and operable and various locations.

### SUMMARY OF THE INVENTION

The present invention is a system for tracking, locating and guiding personnel within a defined location. The system comprises a personnel transmitter and receiver transportable by a user, a plurality of mobile wireless transmittal and receiving stations positioned around the periphery of the location, each effective for transmitting a signal to the personnel transmitter and receiver. The personnel transmitter and receiver is coupled to a microprocessor that operates to determine the coordinates of the user within the location.

In another preferred embodiment of the invention the signal is a directed signal.

In another preferred embodiment of the invention the system further comprises a central processing and communication system for monitoring personnel within the location.

In another preferred embodiment of the invention the personnel transmitter and receiver comprises an electronic display means.

In another preferred embodiment of the invention the personnel transmitter and receiver further comprises a sensor apparatus having one or more sensors effective for sensing environmental conditions.

In another preferred embodiment of the invention each said personnel transmitter and receiver is effective for transmitting sensor information to a central processing and communication system.

In another preferred embodiment of the invention the system further comprises a plurality of deployable sensor arrays, wherein each sensor array comprises one or more sensors effective for sensing various conditions at their deployed locations.

In another preferred embodiment of the invention each sensor array includes a transmitter means for transmitting sensor information to each personnel transmitter and receiver.

In another preferred embodiment of the invention each sensor array includes a transmitter means for transmitting sensor information, wherein sensor information is received by a central processing and communication system.

In another preferred embodiment of the invention each personnel transmitter and receiver further comprises a sensor apparatus having one or more sensors effective for sensing the physical conditions of the user.

In another preferred embodiment of the invention the system further comprises an electronic display and means for inputting digital maps for display on the display means.

Another embodiment of the invention is a system for tracking, locating and guiding personnel within a defined location, the system comprises a plurality of mobile wireless transmittal and receiving stations positioned around the periphery of the location, each effective for transmitting a directed signal to personnel transmitter and receivers on the users, a sensor apparatus having one or more sensors effective for sensing various environmental conditions, and a central processing and communication system, wherein the personnel transmitter and receiver is coupled to a microprocessor that operates to determine the coordinates of the user within the location, and wherein the personnel transmitter and receiver automatically transmits the vertical, latitudinal and longitudinal location of the user to the central processing and communication system for coordinating and directing the activities of personnel within the location.

Another embodiment of the invention is a method for tracking, locating and guiding personnel at a location comprising the steps of defining a location, positioning a plurality of wireless transmittal and receiving stations along the periphery of the location, providing each personnel entering into the location with a personnel transmitter and receiver, wherein the wireless transmittal and receiving stations operate to provide directed signals in to the location, wherein each personnel transmitter and receiver is electronically coupled to a microprocessor that operates to use the directed signals to determine the coordinates of the user within the location.

In another preferred embodiment of the invention, the method further comprises the step of transmitting and displaying a digital map on the display device of the personnel transmitter and receiver.

In another preferred embodiment of the invention, the method further comprises the step of using a sensor apparatus having a plurality of sensors for sensing various environmental conditions within the location.

In another preferred embodiment of the invention, the method further comprises the step of deploying one or more sensor arrays within the location.

In another preferred embodiment of the invention, the method further comprises the step of using one or more of the sensor arrays for obtaining information for use in evaluating and providing guidance and/or warnings to personnel within the location.

### BRIEF DESCRIPTION OF THE DRAWINGS

These and other features, aspects, and advantages of the present invention will become better understood with regard to the following description, appended claims, and accompanying drawings where:

FIG. 1 is a schematic representation of a system for tracking, locating and guiding personnel at a location showing a defined location, a plurality of wireless transmittal and receiving stations positioned around the periphery of the location;

FIG. 2 is a schematic representation of a personnel transmitter and receiver electronically coupled to a microprocessor and an electronic display means;

FIG. 3 is a schematic representation of the system for tracking, locating and guiding personnel comprising a deployable sensor array having one or more sensors for sensing various environmental conditions at a deployed location;

FIG. 4 is a schematic representation of a central processing and communication system comprising a computer system having a controller, a processor and a memory, an input device and an output device;

FIG. 5 is a schematic representation of a sensor array having one or more sensors electronically coupled to a microprocessor;

FIG. 6 is a schematic representation of the system for tracking, locating and guiding personnel at more than one defined location; and

FIG. 7 is a schematic representation illustrating the general methodology of the method of the subject invention for tracking, locating, and guiding personnel at a location.

### DETAILED DESCRIPTION OF THE INVENTION

The present invention solves the prior art problems discussed above and provides a distinct advance in the state of the art. The system and method for tracking, locating, and guiding personnel at a location, preferably is a computer-aided system that operates to provide an improved communication system whereby individuals can be tracked and guided and can communicate with a central processing and communication system as well as other individuals within the system. In one preferred embodiment the system comprises a plurality of wireless transmittal and receiving stations positioned around the periphery of a defined location. Each transmittal and receiving station operates by transmitting a signal into the location for reception by each personnel transmitter and receiver and further includes an antenna effective for receiving signals being directed outwardly from the defined location. In a preferred embodiment of the invention, the signal be transmitted into the location is a directed signal using a relatively narrow beam-width. In other preferred embodiments, the system comprises sensors that operate to sense and obtain information and transmits the information for review and analysis.

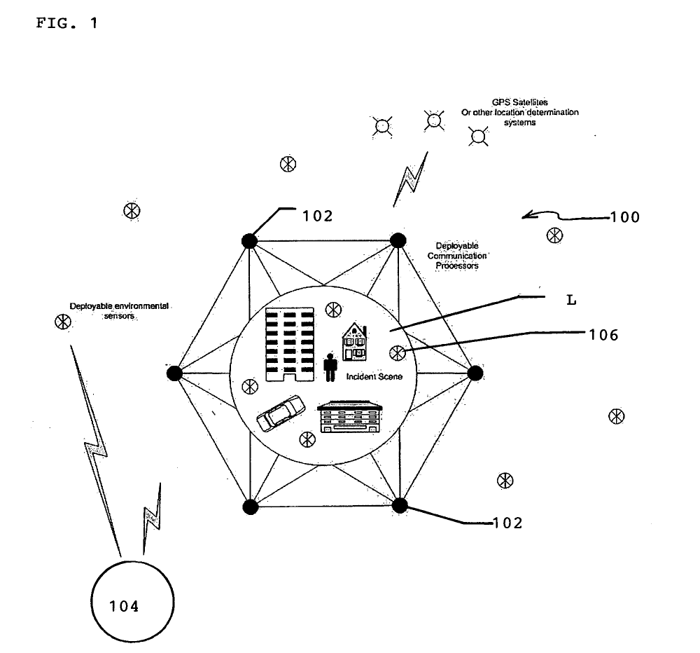

Referring to FIG. 1, the system for tracking, locating, and guiding personnel at a location 100 comprises a plurality of wireless transmittal and receiving stations 102 positioned around the periphery of a defined location L. Preferably, the wireless transmittal and receiving stations 102 are mobile and can be easily transported to and placed at desired positions along the periphery of the location L. In a preferred embodiment three wireless transmittal and receiving stations 102 are utilized but it should be understood that depending on the size of the defined location, more stations may be utilized, preferably six or more stations. The wireless transmittal and receiving stations 102 are in communication with a central processing and communication system 104 either through a wireless system or by hardwire. Referring to FIGS. 1, 2 and 3, personnel P, such as emergency personnel, entering into the location L who are to be monitored, tracked and guided are each equipped with a personnel transmitter and receiver 106 that receives signals being transmitted by the wireless transmittal and receiving stations 102. Each wireless transmittal and receiving station 102 operates by transmitting a signal S into the location L for reception by each personnel transmitter and receiver 106 and includes one or more antennas effective for receiving signals S being directed outwardly from the defined location L. In a preferred embodiment the signal S is a directed signal using a relatively narrow beam-width. Each personnel transmitter and receiver 106 includes a microprocessor 108 which uses the signals S being transmitted by the plurality of wireless transmittal and receiving stations 102 to determine the coordinates (latitudinal, longitudinal, and vertical location) of the user being tracked. It should be understood that various conventional techniques using the transmitted signals may be utilized for tracking the position of personnel. Such techniques include, but are not limited to, triangulation, radio frequency triangulation, and other similar systems. In another preferred embodiment of the invention, the personnel transmitter and receiver 106 includes a back-up altimeter 109 for confirming the altitude or vertical position of the user.

It should now be apparent that the use of wireless transmittal and receiving stations 102 positioned around the periphery of a location L reduces the number of external influences, such as signal reception and/or interference, difficulties due to atmospheric/ionospheric conditions and satellite clock errors that can affect conventional GPS accuracy. Further, it should now be apparent to those skilled in the art that the use of external wireless transmittal and receiving stations placed around the periphery of a location allows personnel entering into the location to wear or carry less powerful, lighter, and smaller transmitters and receivers than are often required for other tracking systems and reduces the likelihood of outside interference.

In a preferred embodiment, an individual's location is displayed to the user by use of a conventional electronic display means 110, such as a computer screen, a wearable device, audio signals, head mounted or heads-up displays, hand held displays, and other similar display systems and devices.

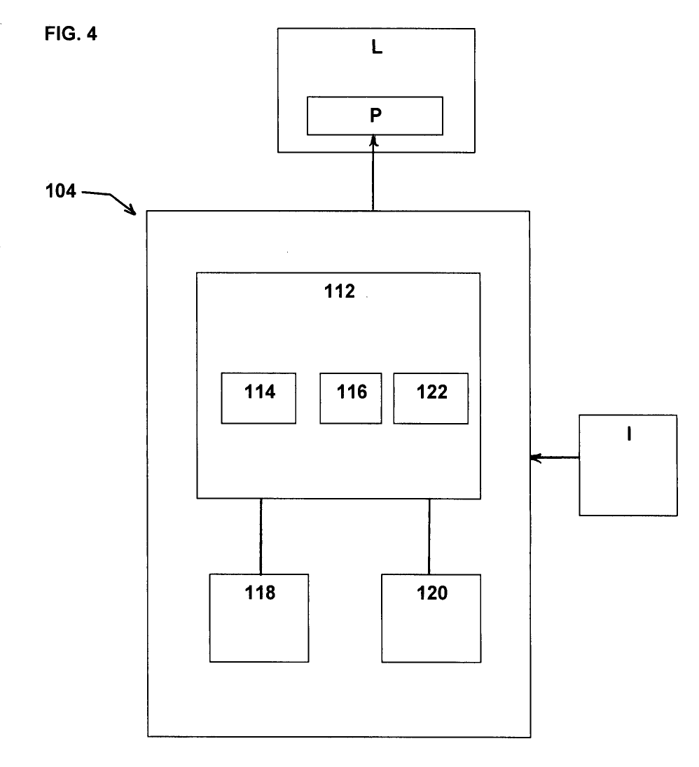

In another preferred embodiment of the invention, once the location of the personnel P being tracked has been calculated by the microprocessor 108, the coordinates are displayed to the user by the electronic display means 110 and are automatically transmitted by the personnel transmitter and receiver 106 to the wireless transmittal and receiving stations 102 which forwards the information to the central processing and communication system 104 as well as to the personnel transmitter and receivers of other personnel within the location L. In a preferred embodiment of the invention, as shown in FIG. 4, the central processing and communication system 104 comprises a computer system 112 having a controller 114, a processor and a memory 116 that may be coupled to other devices, such as a suitable input device 118, like a keypad, touch screen, and suitable output devices 120, such as a computer display, printer, and the like. It should be understood that the computer system 112 can include any combination of the above components, or any number of different components, peripherals, and other devices. Preferably, the computer system 112 operates under the control of an operating system, such as the WINDOWS™ operating system developed by Microsoft Corporation or the Macintosh™ operating system developed by Apple Computer Corporation. It should be understood that other similar operating systems can also be used. The computer system 112 may also include input/output portals 122, such as those conventionally used for connecting to input/output Internet terminals, such as phone lines, wireless systems, and the like.

In a preferred embodiment of the invention, the central processing and communication system 104 is provided with location information I which can be stored in its processor and memory 106 using the input device 118 or by directly downloading the location information I from various systems or networks, such as but not limited to the Internet, using input/output portals 122. Location information I may include detailed listings and locations of emergency equipment and systems installed or previously placed at the location L, non-emergency personnel believed to be at the location L, hazardous materials, and other location information I that may be important to emergency personnel. Such location information I can then be reviewed and sent to one or more of the personnel P being tracked and monitored at the location L and displayed on the user's display means 110. In another preferred embodiment of the invention, location information I may also include digital maps, such as floor plans, neighborhood maps, terrain maps, and the like. For one illustrative example, location information I in the form of digital floor plans is inputted into the processor and memory 106 such as by way of the Internet. Information concerning the location of personnel P received by the central processing and communication system 104 can be overlaid onto the floor plans thereby allowing personnel coordinators monitoring personnel P within the location L to identify the specific locations of such personnel P with respect to the location L. Information can then be used to coordinate and direct the activities of all personnel P within the location L. Other pertinent location information I, such as but not limited to, location of emergency equipment and systems installed or previously placed at the location L, non-emergency personnel believed to be at the location L, and the location of hazardous materials may also be indicated. In another preferred embodiment, the central processing and communication system 104 operates to update and transmit location information I to personnel P. For another illustrative example, the location L is an area within a neighborhood or community. Location information I in the form of digital site or terrain maps can be inputted into the processor and memory 106 of the computer system 112. Location of personnel P received by the central processing and communication system 104 can be overlaid onto the digital map thereby specifically positioning the location of personnel P with respect to the location L. Such information can then be displayed on the output device 120 and used to coordinate and direct the activities of all personnel P within the location L. Other pertinent location information I, such as but not limited to, danger areas, such as construction areas, open holes, cliffs, hazardous materials, dangerous animals, and non-emergency personnel believed to be at the location L may also be indicated. The digital map together with location information can then be transmitted to one or more of the personnel transmitter and receivers and displayed on the user's display means 110.

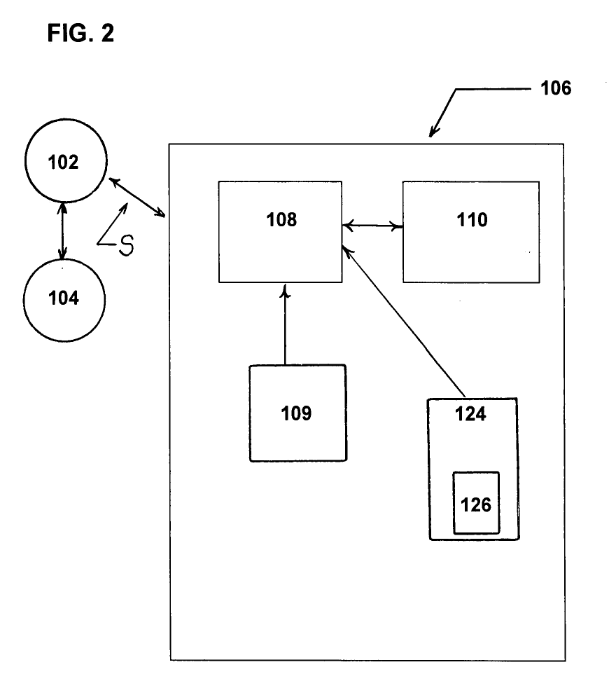

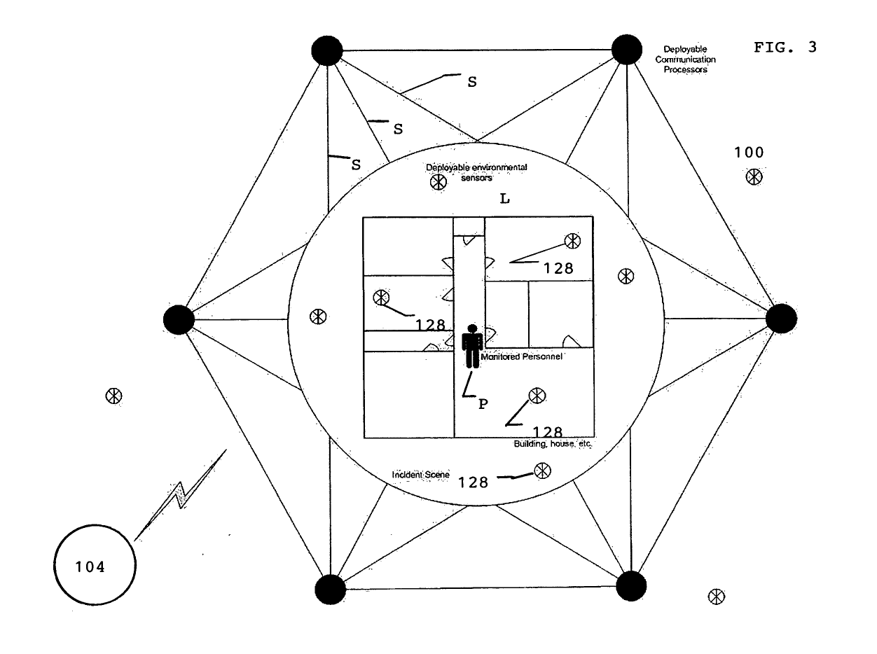

In another preferred embodiment of the invention, as shown in FIGS. 2 and 3, each personnel transmitter and receiver 106 is provided with a sensor apparatus 124 that includes one or more sensors 126 that are electronically coupled to the microprocessor 108. The particular type and function of the sensor apparatus will depend on the duties of the personnel P carrying the transmitter and receiver 106. For an illustrative example, for emergency personnel, such as firefighters, the sensor apparatus 124 comprises one or more sensors 126 effective for sensing various environmental conditions such as ambient air temperature, oxygen levels, the existence and concentration of harmful or hazardous chemicals and gases, radiation, and the like. Input from one or more of the sensors 126 may operate to activate the microprocessor 108 to generate an alarm or single to relevant personnel P warning them to take appropriate action. Sensor inputs received by the microprocessor 108 will be automatically transmitted to the central processing and communication system 104 by way of the wireless transmittal and receiving stations 102. In another illustrative example, the sensor apparatus 124 comprises one or more sensors 126 effective for sensing the physical conditions of the user, such as skin temperature, heart rate, blood pressure, breathing rate, and the like. In another preferred embodiment the sensor apparatus 124 includes a video camera and/or an audio receiver 125 allowing video images and/or audio to be transmitted to the central processing and communication system 104 and to other personnel within the location L. It should be apparent that the use of video and/or audio allows coordinators to better assess conditions within the location L as well as allowing the user to receive instructions based on the images. In addition, it should now be apparent that personnel monitoring or reviewing video images could identify concerns, such as weapons or hazardous conditions, warnings and the like. In addition, the video camera could include one or more types, such as, but not limited to, normal images, infrared images, zoom capabilities, and the like. In another preferred embodiment each personnel transmitter and receiver 106 can be operable for receiving a signal from the wireless transmittal and receiving stations 102 that is used by the microprocessor 108 to activate or deactivate the personnel transmitter and receiver 106 or one or more of the sensors 126 of the sensor apparatus 124.

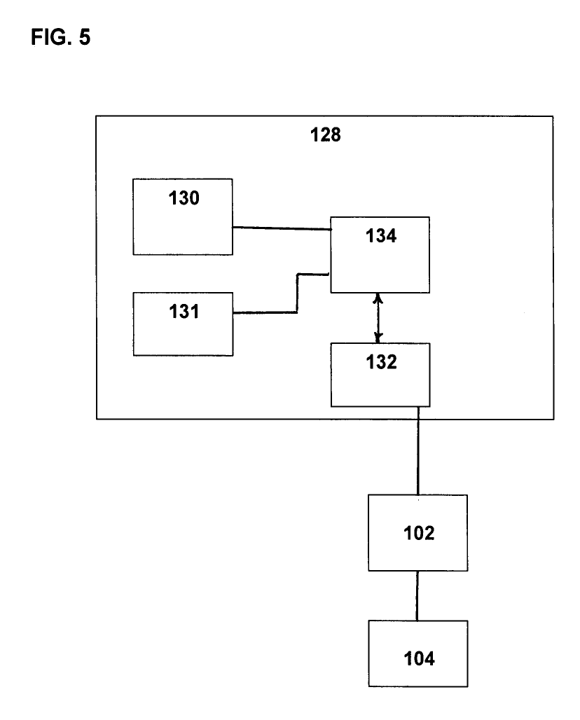

In another preferred embodiment of the invention, as shown in FIGS. 3 and 5, the system for tracking, locating, and guiding personnel at a location 100 further comprises one or more deployable sensor arrays 128. Preferably, such sensor arrays 128 are transported by personnel P entering into a location L and are positioned at localities within the location L. Such sensor arrays 128 comprise one or more sensors 130 effective for sensing various conditions such as ambient air temperature, oxygen levels, the existence and concentration of harmful or hazardous chemicals and gases, radiation, and the like. Further, sensor arrays 128 may comprise stationary or rotatable cameras 131. Sensors 130 may also be placed on surfaces such as floors, walls, ceilings, doors, gas canisters, and the like for sensing surface temperature. Each sensor array 128 further comprises a transmitter 132 and a microprocessor 134 which is coupled to the sensors 130 comprising the sensor array 128. The microprocessor 134 operates to analyze signals from the sensors 130 and produce readings which are then transmitted by the transmitter 132 to wireless transmittal and receiving stations 102 which forwards the information to the central processing and communication system 104. The central processing and communication system 104 then operates to transmit such information to all relevant personnel P within the location L. For an illustrative example, in fire fighting it has been found that once the ambient temperature at a location reaches about 600° F., the temperature at that location may quickly climb to more than 1100° F. At this temperature a process known as flashover can occur in which the air at the location ignites. Anyone at that location may be severely injured or even killed. Further, fire believed to be isolated to one location often travels unseen and unnoticed, such as through rafters, walls, crawl spaces, and the like, and breaks out at other distant locations. Emergency personnel, such as firefighters, entering and traveling into the location may find themselves cutoff from exit routes. Accordingly, by properly deploying one or more sensor arrays along critical evacuation or exit routes can provided data which can evaluated and used for providing guidance or warnings to personal working in a hazardous or potentially hazardous environments that evacuation or exit routes may be in danger.

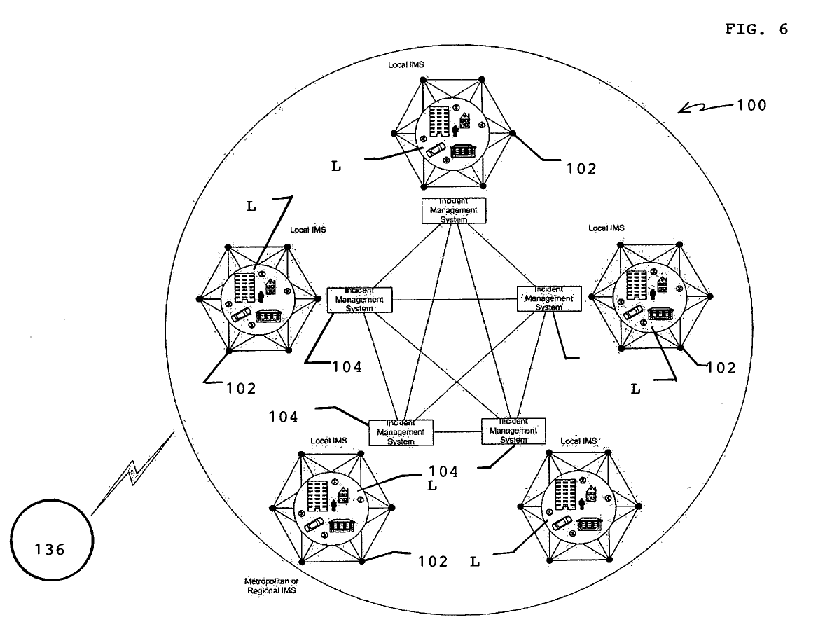

Although as shown above as a single location, it should now be understood that multiple locations L may exist, covering discontiguous portions of the system 100. For example, referring to FIG. 6, another preferred embodiment of the invention is shown whereby the system for tracking, locating, and guiding personnel at a location 100 comprises a plurality of locations L, each location L having a plurality of wireless transmittal and receiving stations 102 positioned around the periphery of each location L. As described above, each wireless transmittal and receiving station 102 is in communication with a respective central processing and communication system 104 either through a wireless system or by hardwire. As illustrated, the central processing and communication systems 104 are in direct communication with each other as well as a overseeing processing and communication system 136 that operates to receive information from each central processing and communication system 104 allowing centralized coordination and personnel management.

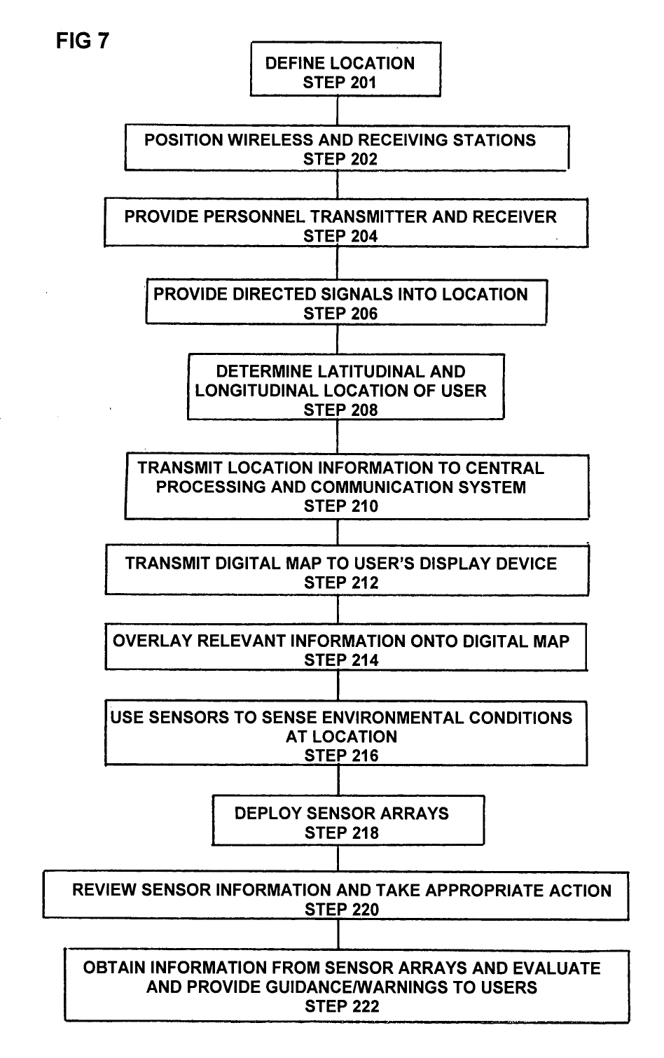

Referring to FIG. 7, the method for tracking, locating, and guiding personnel at a location is shown. In a preferred embodiment of the invention the method comprises the steps of first defining a location (step 201). A plurality of wireless transmittal and receiving stations are then placed along the periphery of the location (step 202) and personnel entering into the location are each provided with a personnel transmitter and receiver (step 204). As discussed above, the wireless transmittal and receiving stations operate to provide signals, more preferably directed signals, into the location (step 206). Each personnel transmitter and receiver within the location, using the microprocessor, operates to use the directed signals to determine the coordinates of the user within the location (step 208). Location information is then transmitted to the central processing and communication system for analysis (step 210).

In another preferred embodiment of the invention, the method further comprises the step of transmitting a digital map to each personnel transmitter and receiver for display on the user's display device (step 212). Preferably, the location of each user, and other relevant information as discussed above, is overlaid onto the digital map (step 214).

In another preferred embodiment of the invention, the method further comprises the step of using a sensor apparatus having a plurality of sensors for sensing various environmental conditions within the location (step 216).

In another preferred embodiment of the invention, the method further comprises the step of deploying one or more sensor arrays within the location (step 218). Sensor information is then received (as described above) and reviewed and appropriate action is performed by personnel (step 220).

In another preferred embodiment of the invention, the method further comprises the step of using one or more of the sensor arrays for obtaining information and using the information to evaluate and provide guidance and/or warnings to personnel within the location (step 222).

It should now be apparent to those skilled in the art that the system and method for tracking, locating, and guiding personnel of the present invention can be constructed such that the apparatus carried by personnel is relatively light weight and small in size and that the entire system is relatively inexpensive to manufacture and operate, can be easily and quickly implemented, and operable at various locations and for various purposes such as, but not limited to, incident management; emergency management; law enforcement, fire, EMS, DoD crash scene investigators, and other critical and specialized personnel. It should also now be apparent that the use of wireless transmittal and receiving stations positioned around the periphery of a location reduces the number of external influences, such as signal reception and/or interference, difficulties due to atmospheric/ionospheric conditions and satellite clock errors that can affect conventional GPS accuracy. Further, it should now be apparent to those skilled in the art that the use of external wireless transmittal and receiving stations placed around the periphery of a location allows personnel entering into the location to wear or carry less powerful, lighter, and smaller transmitters and receivers than are often required for other tracking systems and reduces the likelihood of outside interference.

It should be understood that, because some of the system components and steps and processes depicted in the accompanying drawings and described herein may be implemented in software, the actual connections between the system components or the process steps may differ depending upon the manner in which the present invention is utilized. One of ordinary skill in the art using the teachings contained herein will be able to contemplate these and similar implementations and configurations of the present disclosure.

Although the foregoing invention has been described in some detail for purposes of clarity of understandings, it will be apparent that certain changes and modifications may be practiced within the scope of the appended claims. Furthermore, it should be noted that there are alternative ways of implementing both the method and article for implementing the method of the present invention. Accordingly, the present embodiments and examples are to be considered as illustrative and not restrictive, and the invention is not to be limited to the details given herein, but may be modified within the scope and equivalents of the appended claims.

We claim:

1. A system for tracking, locating and guiding personnel within a defined location, the system comprising:
a personnel transmitter and receiver transportable by a user;
a plurality of mobile wireless transmittal and receiving stations positioned around the periphery of the location, each effective for transmitting a signal to said personnel transmitter and receiver;
wherein said personnel transmitter and receiver includes a microprocessor that operates to determine the coordinates of the user within the location.

2. The system of claim 1 wherein the signal is a directed signal being transmitted into the location.

3. The system of claim 1 further comprising a central processing and communication system for monitoring the location of personnel within the location.

4. The system of claim 1 wherein each said personnel transmitter and receiver comprises an electronic display means.

5. The system of claim 1 wherein each said personnel transmitter and receiver further comprises a sensor apparatus having one or more sensors effective for sensing environmental conditions.

6. The system of claim 5 wherein said sensor apparatus includes a video camera for transmitting video images.

7. The system of claim 5 wherein each said personnel transmitter and receiver is effective for transmitting sensor information to a central processing and communication system.

8. The system of claim 5 wherein said personnel transmitter and receiver are effective for receiving sensor information from other personnel transmitter and receivers.

9. The system of claim 1 further comprising a plurality of deployable sensor arrays, wherein each said sensor array comprises one or more sensors effective for sensing various conditions at their deployed locations.

10. The system of claim 9 wherein each said sensor array includes transmitter means for transmitting sensor information to each said personnel transmitter and receiver.

11. The system of claim 9 wherein each said sensor array includes a transmitter means for transmitting sensor information, wherein said sensor information is received by a central processing and communication system.

12. The system of claim 1 wherein each said personnel transmitter and receiver further comprises a sensor apparatus having one or more sensors effective for sensing the physical conditions of the user.

13. The system of claim 1 further comprising an electronic display means and means for inputting digital maps and for displaying said maps on said display means.

14. A system for tracking, locating and guiding personnel within a defined location, the system comprising:
a personnel transmitter and receiver transportable by a user;
a plurality of mobile wireless transmittal and receiving stations positioned around the periphery of the location each effective for transmitting a directed signal to said personnel transmitter and receiver;
a sensor apparatus having one or more sensors effective for sensing various environmental conditions; and
a central processing and communication system;
wherein said personnel transmitter and receiver includes a microprocessor that operates to determine the coordinates of the user within the location; and
wherein said personnel transmitter and receiver automatically transmits the coordinates of the user to said central processing and communication system for coordinating and directing the activities of personnel within said location.

15. The system of claim 14 further comprising a plurality of deployable sensor arrays, wherein each said sensor array comprises one or more sensors effective for sensing various conditions at their deployed locations.

16. The system of claim 14 wherein each said sensor array includes transmitter means for transmitting sensor information to each said personnel transmitter and receiver.

17. The system of claim 14 wherein each said sensor array includes a transmitter means for transmitting sensor information, wherein said sensor information is received by said central processing and communication system.

18. A method for tracking, locating and guiding personnel at a location comprising the steps of:
defining a location;
positioning a plurality of wireless transmittal and receiving stations along the periphery of the location;
providing personnel entering into the location with a personnel transmitter and receiver;
wherein the wireless transmittal and receiving stations operate to provide signals in to the location;
wherein each personnel transmitter and receiver includes a microprocessor that operates to use the signals to determine the coordinates of the user within the location.

19. The method of claim 18 further comprising the step of transmitting to displaying a digital map on the display device of the personnel transmitter and receiver.

20. The method of claim 18 further comprising the step of using a sensor apparatus having a plurality of sensors for sensing various environmental conditions within the location.

21. The method of claim 18 further comprising the step of deploying one or more sensor arrays within the location.

22. The method of claim 21 further comprising the step of using one or more of the sensor arrays for obtaining information for use in evaluating and providing guidance and/or warnings to personnel within the location.
